(19) United States
(12) Patent Application Publication
(10) Pub. No.: US 2025/0166947 A1
(43) Pub. Date: May 22, 2025

(54) PROTECTIVE ELEMENT

(71) Applicant: DEXERIALS CORPORATION, Shimotsuke-shi, Tochigi (JP)

(72) Inventor: Yoshihiro YONEDA, Shimotsuke-shi, Tochigi (JP)

(73) Assignee: DEXERIALS CORPORATION, Shimotsuke-shi, Tochigi (JP)

(21) Appl. No.: 18/841,502

(22) PCT Filed: Feb. 22, 2023
(86) PCT No.: PCT/JP2023/006445

§ 371 Date: Aug. 26, 2024

(30) Foreign Application Priority Data
Mar. 2, 2022 (JP) 2022-031613

(51) Int. Cl. H01H 37/32; H01H 85/06; H01H 85/08; H01H 85/143; H01M 50/583

(52) U.S. Cl. CPC H01H 37/32; H01H 85/06; H01H 85/08; H01H 85/143; H01M 50/583; H01M 2200/103

(57) ABSTRACT

A protective element includes: an insulating substrate; a heat-generating body disposed on either one face side or the other face side of the insulating substrate; a first electrode and a second electrode disposed on the other face side of the insulating substrate; an extraction electrode disposed between the first electrode and the second electrode and electrically connected to one end side of the heat-generating body; a third electrode electrically connected to the other end side of the heat-generating body; and a fusible conductor disposed on a face of the first electrode, the second electrode, and the extraction electrode. A surface area of the fusible conductor disposed on a face of the extraction electrode is smaller than each of a surface area of the fusible conductor disposed on a face of the first electrode and a surface area of the fusible conductor disposed on a face of the second electrode.

### TECHNICAL FIELD

The present invention relates to a protective element.

The present application claims priority to JP 2022-031613 filed in Japan on Mar. 2, 2022, the contents of which are hereby incorporated herein by reference.

### BACKGROUND ART

A protective element is known in which a fuse element (fusible conductor) that generates heat and melts when an overcurrent exceeding the rated value is applied to a circuit board, thereby interrupting the current path. Furthermore, a protective element is known in which a heater (heat-generating body) is placed inside, and in an abnormal condition other than the occurrence of overcurrent, the heater is made to generate heat by energizing the heater, and the heat is used to melt the fuse element.

For example, the following patent documents 1 and 2 disclose a protective element having a first fuse element and a second fuse element connected in series and a heater connected between the first and second fuse elements.

In such protective elements, when an overcurrent occurs, a typical fuse operation is to cut off the current path by melting the fuse element. Conversely, when an overvoltage is detected, the heater is made to generate heat by energizing the heater, and the heat is used to melt the fuse element, thereby disconnecting the current path and also disconnecting the power to the heater.

For example, in a secondary protection circuit of rechargeable batteries such as lithium-ion batteries, a protective element called a surface-mounted heater-attached fuse (SCP: Self Control Protector) is used to physically perform irreversible interruption of a charge/discharge circuit. In this SCP, power is supplied from the rechargeable battery itself to the heater in the event of an overvoltage anomaly, causing the heater to heat up and melt the fuse element.

### PRIOR ART DOCUMENTS

### Patent Documents

Patent Document 1: JP 2013-239405 A
Patent Document 2: JP 5923153

### SUMMARY OF INVENTION

### Problem to be Solved by Invention

By way of mention, in the conventional protective element described above, when the heat-generating body is heated and the heat is used to melt the fuse element, a part of the fusible conductor, which should be split between the electrodes, sometimes remains connected to the fuse element between the electrodes.

The present invention has been proposed in light of such conventional circumstances, and an object thereof is to provide a protective element that makes it possible to properly fuse a fusible conductor between a first electrode, a second electrode, and an extraction electrode by heat generated by a heat-generating body.

### Means for Solving Problem

In order to achieve the foregoing object, the present invention provides the following means.
[1] A protective element provided with:
an insulating substrate;
a heat-generating body disposed on either one or the other side of the insulating substrate;
a first electrode and a second electrode disposed on the other side of the insulating substrate;
an extraction electrode disposed between the first electrode and the second electrode and electrically connected to one end side of the heat-generating body;
a third electrode electrically connected to the other end side of the heat-generating body; and
a fusible conductor disposed on a face of the first electrode, the second electrode, and the extraction electrode, and electrically connecting the first electrode to the extraction electrode and the second electrode to the extraction electrode; wherein
a surface area of the fusible conductor disposed on a face of the extraction electrode is smaller than a surface area of the fusible conductor disposed on a face of the first electrode and a surface area of the fusible conductor disposed on a face of the second electrode.
[2] The protective element according to [1] above, wherein when the fusible conductor is fused between the first electrode and the extraction electrode, as well as between the second electrode and the extraction electrode, a maximum thickness of the fusible conductor remaining on the face of the extraction electrode is smaller than a maximum thickness of the fusible conductors remaining on the faces of the first electrode and the second electrode.
[3] The protective element according to [1] or [2] above, wherein the first electrode and the second electrode have, in plan view, a shape that is convexly curved from the center side to both end sides in the width direction at the edge of the side facing the extraction electrode, respectively.
[4] The protective element according to any one of [1] to [3] above, wherein the fusible conductor is heated and fused either by heat generated by the current flowing in the heat-generating body or by Joule heat generated by an overcurrent flowing between the first electrode and the second electrode.
[5] The protective element according to any one of [1] to [4] above, wherein the heat-generating body is disposed on one face side of the insulating substrate.
[6] The protective element according to any one of [1] to [5] above, further provided with a through electrode that electrically connects the heat-generating body and the extraction electrode while penetrating through the insulating substrate.
[7] The protective element according to any one of [1] to [6] above, wherein the heat-generating body is disposed so that at least a portion thereof overlaps each of the first electrode, the second electrode, and the extraction electrode in plan view.
[8] The protective element according to [6] above, wherein the extraction electrode is disposed between the first electrode and the second electrode, led outward from one side of a region overlapping the fusible conductor in plan view to outside of the region.
[9] The protective element according to [8] above, further provided with a fourth electrode on the other side of the region, being separated from the extraction electrode.
[10] The protective element according to any one of [1] to [9] above, wherein the extraction electrode has, in plan view, a concave shape from the center side to both end sides in the width direction at both ends facing the first electrode and the second electrode, respectively.
[11] The protective element according to any one of [1] to [9] above, wherein the extraction electrode has, in plan view, a concave shape from one end side to the other end side in the width direction at both ends facing the first electrode and the second electrode, respectively.
[12] The protective element according to any one of [1] to [4] above, wherein the heat-generating body is disposed on the other face side of the insulating substrate.
[13] The protective element according to any one of [1] to [12] above, further provided with an insulating layer covering the heat-generating body.
[14] The protective element according to any one of [1] to [13] above, wherein the heat-generating body includes one heat-generating body disposed to overlap at least a portion of the first electrode in plan view and the other heat-generating body disposed to overlap at least a portion of the second electrode in plan view.
[15] The protective element according to any one of [1] to [14] above, wherein the fusible conductor is solder.
[16] The protective element according to [15] above, wherein a flux is disposed on a surface of the fusible conductor.
[17] The protective element according to any one of [1] to [16] above, further provided with a cover member covering the other side of the insulating substrate.

### Effect of Invention

As described above, according to the present invention, it is possible to provide a protective element that makes it possible to properly fuse a fusible conductor between a first electrode, a second electrode, and an extraction electrode by heat generated by a heat-generating body.

### BRIEF DESCRIPTION OF DRAWINGS

FIG. 1 A plan view illustrating a configuration of the protective element of a first embodiment of the present invention.

FIG. 2 A cross-sectional view of the protective element along the line segment A-A′ illustrated in FIG. 1.

FIG. 3 A cross-sectional view of the protective element along the line segment B-B′ illustrated in FIG. 1.

FIG. 4 A circuit diagram illustrating one configuration example of a protection circuit using the protective element illustrated in FIG. 1.

FIG. 5 A plan view illustrating a fusible conductor of the protective element illustrated in FIG. 1 in a fused state.

FIG. 6 A cross-sectional view illustrating the fusible conductor of the protective element illustrated in FIG. 2 in a fused state.

FIG. 7 A plan view illustrating a configuration of the protective element of a second embodiment of the present invention.

FIG. 8 A cross-sectional view of the protective element along the line segment A-A′ illustrated in FIG. 7.

FIG. 9 A plan view illustrating a configuration of the protective element of a third embodiment of the present invention.

FIG. 10 A cross-sectional view of the protective element along the line segment A-A′ illustrated in FIG. 9.

FIG. 11 A plan view illustrating a configuration of the protective element of a fourth embodiment of the present invention.

FIG. 12 A cross-sectional view of the protective element along the line segment A-A′ illustrated in FIG. 11.

FIG. 13 A plan view illustrating a configuration of the protective element of a fifth embodiment of the present invention.

FIG. 14 A cross-sectional view of the protective element along the line segment A-A′ illustrated in FIG. 13.

FIG. 15 A plan view illustrating a configuration of the protective element of a sixth embodiment of the present invention.

FIG. 16 A cross-sectional view of the protective element along the line segment A-A′ illustrated in FIG. 15.

FIG. 17 A plan view illustrating a configuration of the protective element of a seventh embodiment of the present invention.

FIG. 18 A cross-sectional view of the protective element along the line segment A-A′ illustrated in FIG. 17.

FIG. 19 A plan view illustrating a configuration of the protective element of an eighth embodiment of the present invention.

FIG. 20 A cross-sectional view of the protective element along the line segment A-A′ illustrated in FIG. 19.

FIG. 21 A plan view illustrating a configuration of the protective element of a ninth embodiment of the present invention.

FIG. 22 A cross-sectional view of the protective element along the line segment A-A′ illustrated in FIG. 21.

FIG. 23 A plan view illustrating a configuration of the protective element of a tenth embodiment of the present invention.

FIG. 24 A cross-sectional view of the protective element along the line segment A-A′ illustrated in FIG. 23.

### EMBODIMENTS OF INVENTION

Embodiments of the present invention will be described in detail below with reference to the drawings.

Note that the drawings used in the following description may schematically illustrate the characteristic parts for the sake of convenience to make the features easier to understand, and the dimensional proportions of each constituent element may not be the same as in actuality. Furthermore, the materials, dimensions, and the like exemplified in the following description are examples, and the present invention is not necessarily limited thereto, but may be implemented with modifications as appropriate to the extent that the essence thereof is not changed.

Moreover, in the drawings illustrated below, an XYZ Cartesian coordinate system is established, the X-axis direction being a first direction X in the specific plane of the protective element, the Y-axis direction being a second direction Y orthogonal to the first direction X in the specific plane of the protective element, and the Z-axis direction being a third direction Z orthogonal to the defined plane of the protective element, and each is indicated.

### First Embodiment

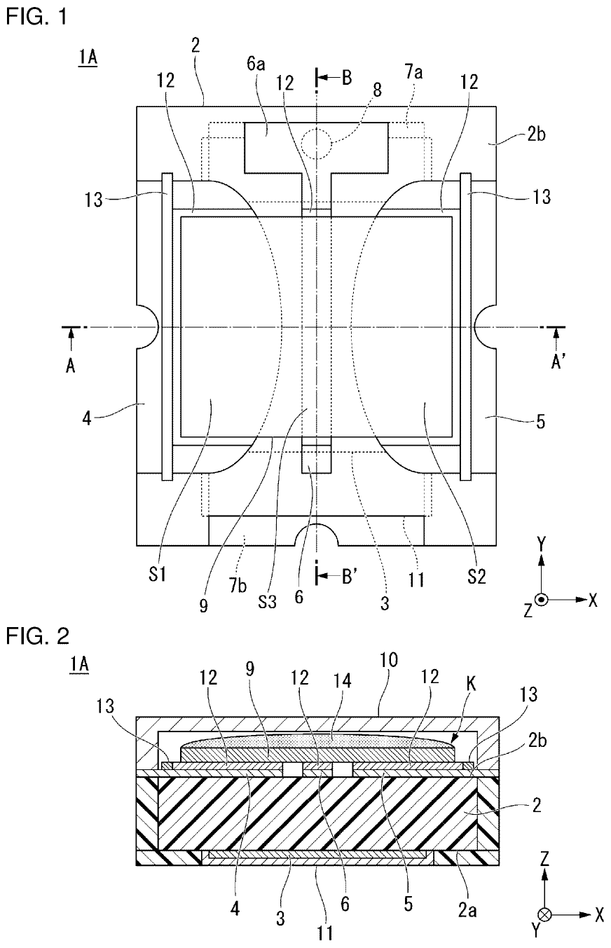

First, as a first embodiment of the present invention, for example, a protective element 1A illustrated in FIGS. 1 to 6 will be described.

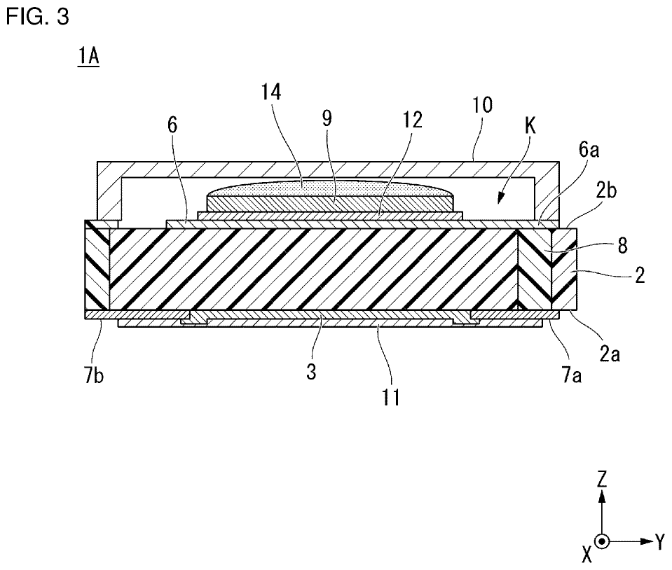

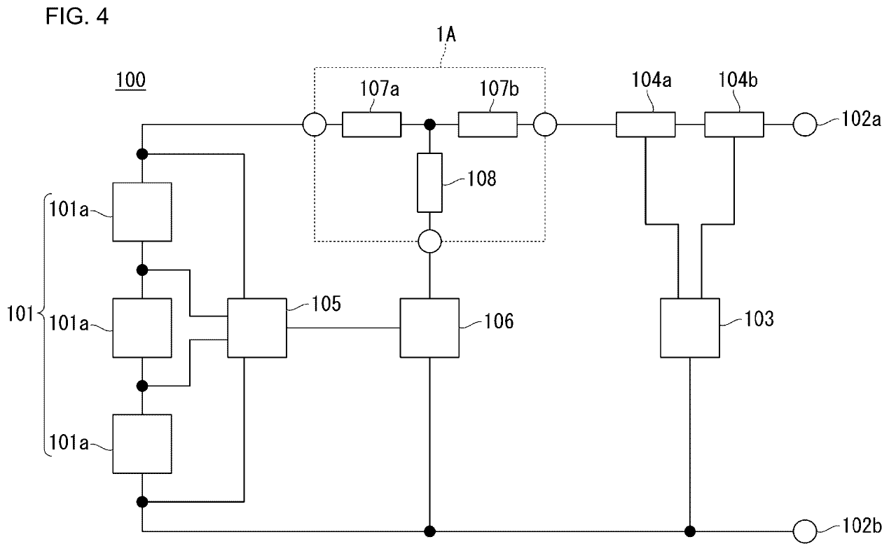

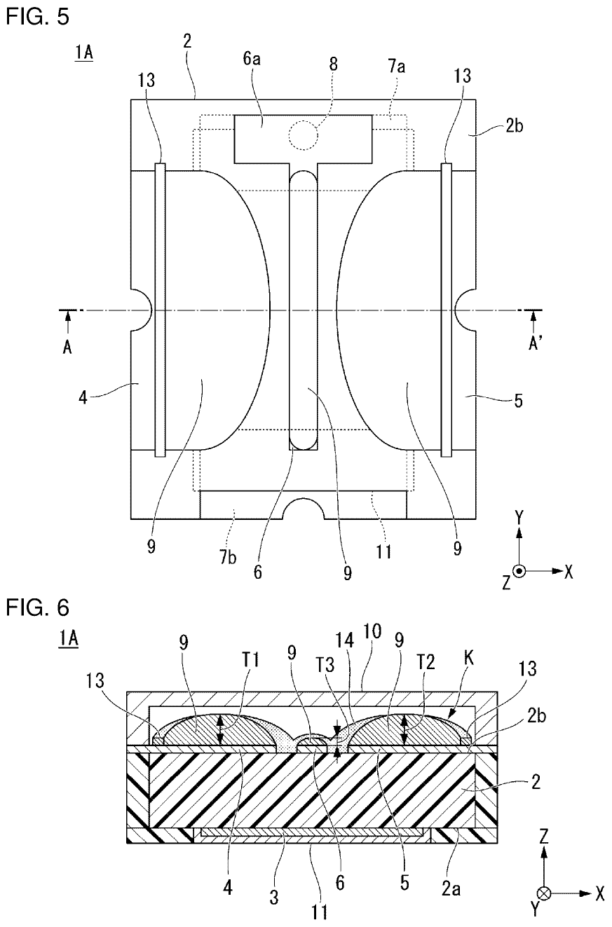

Note that FIG. 1 is a plan view of a configuration of the protective element 1A. FIG. 2 is a cross-sectional view of the protective element 1A along the line segment A-A′ illustrated in FIG. 1. FIG. 3 is a cross-sectional view of the protective element 1A along the line segment B-B′ illustrated in FIG. 1. FIG. 4 is a circuit diagram illustrating one configuration example of a protection circuit 100 using the protective element 1A. FIG. 5 is a plan view illustrating a fusible conductor 9 of the protective element 1A in a fused state. FIG. 6 is a cross-sectional view illustrating a fusible conductor 9 of the protective element 1A in a fused state.

The protective element 1A of the present embodiment is a surface-mounted heater-attached fuse (SCP), for example, for physically performing irreversible disconnection of a charging/discharging circuit in a secondary protection circuit of a rechargeable battery such as a lithium-ion battery.

Specifically, as illustrated in FIGS. 1 to 3, this protective element 1A is provided with an insulating substrate 2, a heat-generating body 3 disposed on either one face (bottom side in the present embodiment) side 2a of the insulating substrate 2, a first electrode 4 and a second electrode 5 disposed on the other face (top side in the present embodiment) side 2b of the insulating substrate 2, an extraction electrode 6 disposed between the first electrode 4 and the second electrode 5, a pair of third electrodes 7a and 7b electrically connected to one end side and the other end side of the heat-generating body 3, a through electrode 8 electrically connecting the third electrode 7a and extraction electrode 6 on the one end side of the heat-generating body 3 while penetrating through the insulating substrate 2, a fusible conductor 9 disposed on a face of the first electrode 4, the second electrode 5, and the extraction electrode 6 and electrically connecting the first electrode 4, the second electrode 5, and the extraction electrode 6, and a cover member 10 covering the other face 2b side of the insulating substrate 2.

The insulating substrate 2 is composed of an insulating material, for example, alumina, glass ceramics, mullite, zirconia, or the like, and is formed as a rectangular flat plate. Other printed wiring substrates such as glass epoxy substrates and phenolic substrates may be used for the insulating substrate 2, for example, but the temperature at the time of fuse blowing should be kept in mind.

The heat-generating body 3 constitutes a heater 108 that heats the fusible conductor 9, which is described later. The heat-generating body 3 is composed of a resistive body that generates heat when an electric current is applied, and is placed on the one face 2a of the insulating substrate 2. Specifically, for example, powder of tungsten (W), molybdenum (Mo), ruthenium (Ru), or an alloy or compound thereof is mixed with a resin binder or the like to form a paste, which is then patterned using screen printing technology on the surface of insulating substrate 2, and then fired or otherwise formed.

The heat-generating body 3 is formed in a rectangular shape such that in plan view, of the mutually orthogonal first direction X and second direction Y on the one face 2a of the insulating substrate 2, the first direction X is the short direction and the second direction Y is the long direction. Furthermore, the heat-generating body 3 is disposed so as to overlap at least a portion of each of the first electrode 4, second electrode 5, and extraction electrode 6 described later in plan view.

An insulating layer 11 covering the heat-generating body 3 is provided on the one face 2a of the insulating substrate 2. The insulating layer 11 is composed of an insulating material such as glass, for example, and is provided to cover the periphery of the heat-generating body 3 except for the face of the heat-generating body 3 facing the insulating substrate 2.

The first electrode 4 and the second electrode 5 are composed of a metallic material, for example, silver (Ag), copper (Cu), or an alloy thereof, and are formed on the other face 2b of the insulating substrate 2 at the same size as each other.

Furthermore, the first electrode 4 and the second electrode 5 are disposed in line with each other having an interval in the first direction X such that in plan view, of the mutually orthogonal first direction X and second direction Y on the other face 2b of the insulating substrate 2, the first direction X is the short direction and the second direction Y is the long direction.

The extraction electrode 6 is formed on the other face 2b of the insulating substrate 2 using, for example, the same metal material as exemplified in the first electrode 4 and second electrode 5 described above. Furthermore, the extraction electrode 6 is located midway between the first electrode 4 and the second electrode 5 and extends in the second direction Y.

Moreover, the extraction electrode 6 is positioned so as to have a region E (+Y axis side in the present embodiment) in which the fusible conductor 9, which is described later, overlaps in plan view, and to be led outward from one side of the region E. A terminal part 6a is provided at one end of the extraction electrode 6.

The pair of third electrodes 7a and 7b is formed on the one face 2a of the insulating substrate 2 using, for example, the same metal material as exemplified in the first electrode 4 and second electrode 5 described above. Furthermore, of the pair of third electrodes 7a of 7b, the one third electrode 7a is electrically connected to one end side of the heat-generating body 3 (+Y axis side in the present embodiment), and the other third electrode 7b is electrically connected to the other end side of the heat-generating body 3 (−Y axis side in the present embodiment). The other third electrode 7b may be connected via a through electrode (through hole) to a surface electrode formed on the other face 2b of the insulating substrate 2.

The through electrode 8 is called a through hole or a castellation, and is formed by embedding a conductive material such as copper (Cu) or gold (Au) by plating, for example, in a hole that passes through the insulating substrate 2 in the thickness direction (third direction Z). The through electrode 8 electrically connects the heat-generating body 3 and the extraction electrode 6 by electrically connecting the terminal part 6a of the extraction electrode 6 to the one third electrode 7a.

The fusible conductor 9 constitutes a first fuse element 107a, which electrically connects the first electrode 4 to the extraction electrode 6, and a second fuse element 107b, which electrically connects the second electrode 5 to the extraction electrode 6, as described below, and is formed from a solder material such as a lead (Pb)-based alloy, a laminate of a low melting point metal (for example, a zinc (Sn)-based alloy) and a high melting point metal (for example, a metal mainly composed of silver (Ag) and copper (Cu)), or the like. Furthermore, in improving solder wettability, it is preferable to perform a plating treatment such as Ni/Au or Ni/Pd/Au to the surfaces of the first electrode 4, second electrode 5, and extraction electrode 6.

The fusible conductor 9 is, for example, disposed on the face of the first electrode 4, the second electrode 5, and the extraction electrode 6 via a connecting conductor 12 composed of a conductive material such as solder or conductive adhesive. Furthermore, an insulating layer 13 is placed on the face of the first electrode 4 and the second electrode 5 along the edge of the connecting conductor 12 on the side opposite to the side facing the extraction electrode 6. Furthermore, a flux 14 is disposed on a surface of the fusible conductor 9.

The cover member 10 is composed of an insulating material such as liquid crystal polymer (LCP) or nylon-based engineering plastic, for example, and is attached to the insulating substrate 2, with a space K between it and the other face 2b of the insulating substrate 2.

By way of mention, in the protective element 1A of the present embodiment, a surface area S3 of the fusible conductor 9 disposed on the face of an extraction electrode 6 is smaller than a surface area S1 of the fusible conductor 9 located on the face of the first electrode 4 and a surface area S2 of the fusible conductor 9 located on the face of the second electrode 5 (S1>S3, S2>S3).

Furthermore, the first electrode 4 and the second electrode 5 have, in plan view, a shape that is convexly curved from the center side towards both end sides in the width direction (second direction Y in the present embodiment) at the edge of the side facing the extraction electrode 6, respectively. In other words, the distance between these the first electrode 4, the second electrode 5, and the extraction electrode 6 gradually increases from the center side to both end sides in the width direction.

The protective element 1A of the present embodiment having a configuration such as the above is suitable for use in a protection circuit 100 that protects a rechargeable battery such as a lithium-ion battery from abnormalities such as overcharge and overcurrent, as illustrated in FIG. 4, for example.

Specifically, this protection circuit 100 is provided with: a battery 101 containing a plurality of rechargeable battery cells 101a; and a primary protection IC 103, a pair of FET switches 104a and 104b, a secondary protection IC 105, and a FET switch 106 between an external positive terminal 102a and an external negative terminal 102b that are electrically connected to an electronic device or charger; the protective element 1A;

The protective element 1A has a first fuse element 107a and a second fuse element 107b connected in series in the energizing path on the external positive terminal 102a side, and a heater 108 connected at one end side between the first fuse element 107a and the second fuse element 107b.

The first fuse element 107a and the second fuse element 107b are composed of the fusible conductor 9 of the protective element 1A described above. The heater 108, conversely, is composed of the heat-generating body 3 of the protective element 1A described above.

The primary protection IC 103 is connected between the energizing path on the external positive terminal 102a side and the energizing path on the external negative terminal 102b side to detect abnormalities of the battery 101 overall.

The pair of FET switches 104a and 104b are connected in series in the energizing path on the external positive terminal 102a side to switch energization based on the detection result of the primary protection IC 103.

The secondary protection IC 105 is connected between each rechargeable battery cell 101a and detects abnormalities in each rechargeable battery cell 101a.

The FET switch 106 is connected between the other end side of the heater 108 and the energizing path on the external negative terminal 102b side and switches energization based on the detection result of the secondary protection IC 105.

In the protection circuit 100 having a configuration such as the above, when an overcurrent is energized during charging of the battery 101, the first fuse element 107a generates heat due to Joule heat and melts, thereby disconnecting the current path. Conversely, when an overcurrent is energized when the battery 101 is discharged, the second fuse element 107b generates heat due to Joule heat and melts, thereby disconnecting the current path.

Conversely, when the secondary protection IC 105 detects an abnormality (for example, overvoltage) in each rechargeable battery cell 101a, the FET 106 is turned on (ON), the heater 108 generates heat due to energization from the battery 101, and that heat is used to melt the first fuse element 107a and second fuse element 107b, thereby disconnecting the current path and simultaneously enabling disconnection of energization to the heater 108.

In the protective element 1A of the present embodiment, the fusible conductor 9 is melted and separated between the first electrode 4 and the extraction electrode 6 and between the second electrode 5 and the extraction electrode 6 when the first fuse element 107a and the second fuse element 107b described above melt, as illustrated in FIG. 5 and FIG. 6.

At this time, the fusible conductor 9 fused by the heat generated by the heat-generating body 3, is wetted and spread over the faces of the first electrode 4 and the second electrode 5 while being dammed by the insulating layer 13 on the faces of the first electrode 4 and the second electrode 5.

In the protective element 1A of the present embodiment, by making the surface area S3 of the fusible conductor 9 located on the face of the extraction electrode 6 smaller than the surface area S1 of the fusible conductor 9 located on the face of the first electrode 4 and the area S2 of the fusible conductor 9 located on the face of the second electrode 5 described above, the fusible conductor 9 fused by heat generated by the heat-generating body 3 can flow into the first electrode 4 and second electrode 5 side more than into the extraction electrode 6 side.

Furthermore, in the protective element 1A of the present embodiment, the edge of the first electrode 4 and the second electrode 5 on the side facing the extraction electrode 6 described above has a convex curved shape in plan view, which can promote the breakup of the fusible conductor 9 between the first electrode 4 and the extraction electrode 6 and between the second electrode 5 and the extraction electrode 6.

As a result, in the protective element 1A after melting, a maximum thickness T3 of the fusible conductor 9 remaining on the face of the extraction electrode 6 is smaller than maximum thicknesses T1 and T2 of the fusible conductor 9 remaining on the faces of the first electrode 4 and the second electrode 5 (T1>T3, T2>T3).

In this way, the protective element 1A of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1A of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Second Embodiment

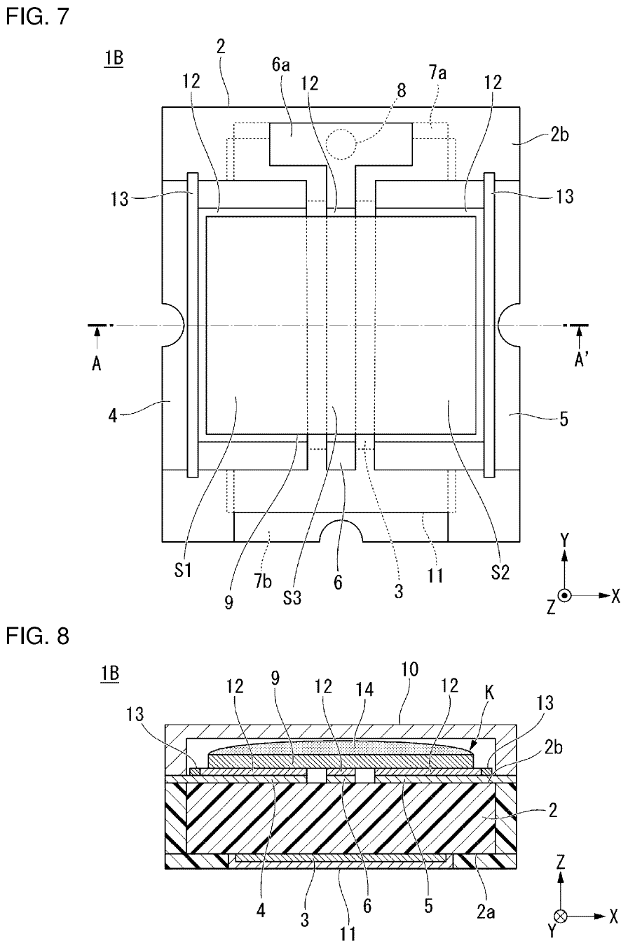

Next, as a second embodiment of the present invention, for example, a protective element 1B illustrated in FIG. 7 and FIG. 8 will be described.

Note that FIG. 7 is a plan view of a configuration of the protective element 1B. FIG. 8 is a cross-sectional view of the protective element 1B along the line segment A-A′ illustrated in FIG. 7. Furthermore, in the following description, parts equivalent to those of the protective element 1A described shall be omitted and the same symbols shall be used in the drawings.

As illustrated in FIGS. 7 and 8, in the protective element 1B of the present embodiment, an edge on the side opposite the extraction electrode 6 of the first electrode 4 and the second electrode 5 is formed linearly. Otherwise, the configuration is substantially the same as that of the above protective element 1A.

Furthermore, the protective element 1B of the present embodiment may be suitably used for the above protection circuit 100 in place of the above protective element 1A.

In the protective element 1B of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In this way, the protective element 1B of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1B of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Third Embodiment

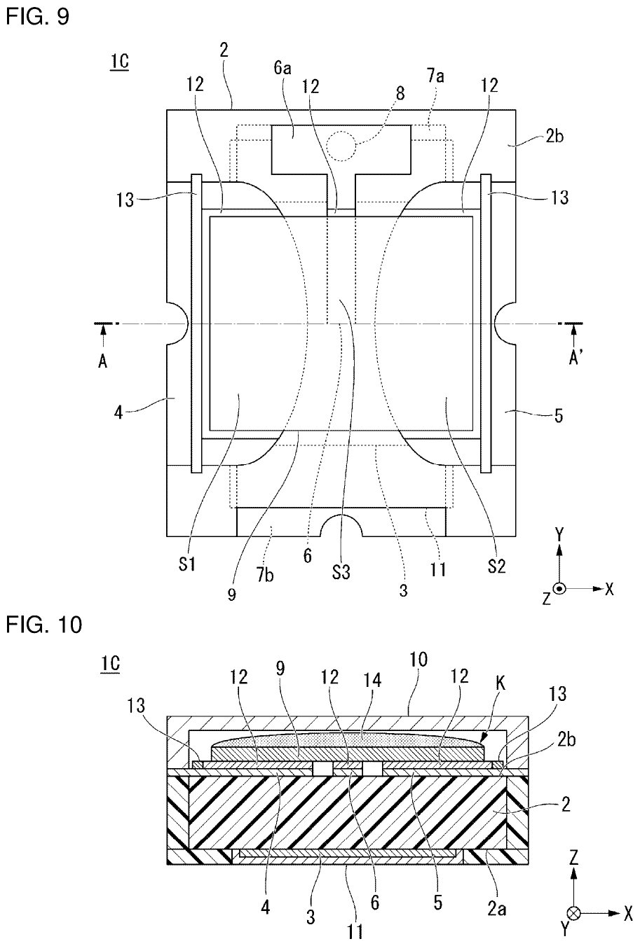

Next, as a third embodiment of the present invention, for example, a protective element 1C illustrated in FIG. 9 and FIG. 10 will be described.

Note that FIG. 9 is a plan view of a configuration of the protective element 1C. FIG. 10 is a cross-sectional view of the protective element 1C along the line segment A-A′ illustrated in FIG. 9. Furthermore, in the following description, parts equivalent to those of the protective element 1A described shall be omitted and the same symbols shall be used in the drawings.

As illustrated in FIGS. 9 and 10, the protective element 1C of the present embodiment has a shorter length in the region E between the first electrode 4 and the second electrode 5, which overlaps in plan view with the fusible conductor 9 of the extraction electrode 6. Otherwise, the configuration is substantially the same as that of the above protective element 1A.

Furthermore, the protective element 1C of the present embodiment may be suitably used for the above protection circuit 100 in place of the above protective element 1A.

In the protective element 1C of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In particular, in the protective element 1C of the present embodiment, by shortening the length in the region E that overlaps in plan view with the fusible conductor 9 of the extraction electrode 6 described above, it is possible to further reduce the possibility of a portion of the fusible conductor 9 remaining connected between the first electrode 4 and the extraction electrode 6 and between the second electrode 5 and the extraction electrode 6.

In this way, the protective element 1C of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1C of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Fourth Embodiment

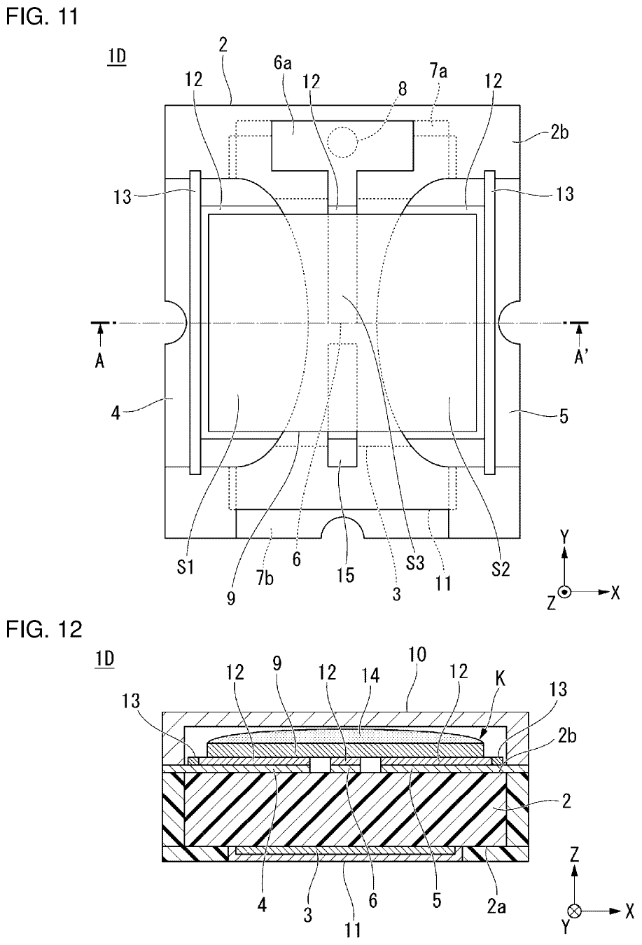

Next, as a fourth embodiment of the present invention, for example, a protective element 1D illustrated in FIG. 11 and FIG. 12 will be described.

Note that FIG. 11 is a plan view of a configuration of the protective element 1D. FIG. 12 is a cross-sectional view of the protective element 1D along the line segment A-A′ illustrated in FIG. 11. Furthermore, in the following description, parts equivalent to those of the protective element 1A described shall be omitted and the same symbols shall be used in the drawings.

As illustrated in FIGS. 11 and 12, the protective element 1D of the present embodiment has a shorter length in the region E between the first electrode 4 and the second electrode 5, which overlaps in plan view with the fusible conductor 9 of the extraction electrode 6. Furthermore, a fourth electrode 15, which is separated from the extraction electrode 6, is provided on the other side of the region E (−Y axis side in the present embodiment). Otherwise, the configuration is substantially the same as that of the above protective element 1A.

The fourth electrode 15 may be formed on the other face 2b of the insulating substrate 2 using, for example, the same metal material as exemplified in the first electrode 4 and second electrode 5 described above. Furthermore, the fourth electrode 15 may be located midway between the first electrode 4 and the second electrode 5 and extends in the second direction Y. Moreover, the other end of the fourth electrode 15 may be disposed outside the fusible conductor 9 in plan view.

Furthermore, the protective element 1D of the present embodiment may be suitably used for the above protection circuit 100 in place of the above protective element 1A.

In the protective element 1D of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In particular, in the protective element 1D of the present embodiment, by shortening the length in the region E that overlaps in plan view with the fusible conductor 9 of the extraction electrode 6 described above, it is possible to further reduce the possibility of a portion of the fusible conductor 9 remaining connected between the first electrode 4 and the extraction electrode 6 and between the second electrode 5 and the extraction electrode 6.

Furthermore, in the protective element 1D of the present embodiment, by providing a fourth electrode 15 separated from the extraction electrode 6 on the other side of the region E of the extraction electrode 6, overlapping in plan view with the fusible conductor 9 described above, even when the length of the extraction electrode 6 is shortened, it is possible to reduce the resistance of the electrically electrode 6 and the fourth electrode 15, which is electrically connected to the first electrode 4 and the second electrode 5 via the fusible conductor 9.

In this way, the protective element 1D of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1D of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Fifth Embodiment

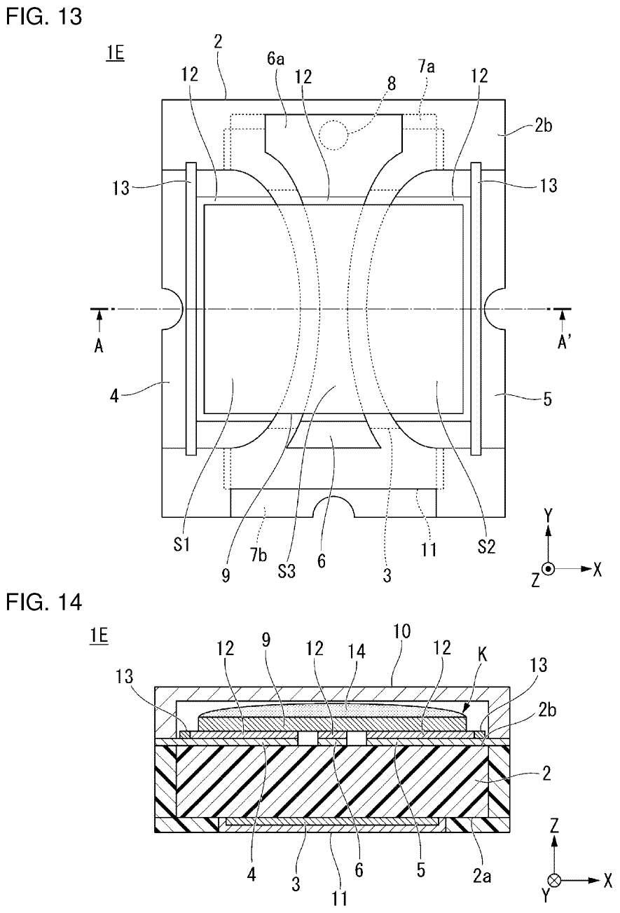

Next, as a fifth embodiment of the present invention, for example, a protective element 1E illustrated in FIG. 13 and FIG. 14 will be described.

Note that FIG. 13 is a plan view of a configuration of the protective element 1E. FIG. 14 is a cross-sectional view of the protective element 1E along the line segment A-A′ illustrated in FIG. 13. Furthermore, in the following description, parts equivalent to those of the protective element 1A described shall be omitted and the same symbols shall be used in the drawings.

As illustrated in FIG. 13 and FIG. 14, in the protective element 1E of the present embodiment, the sides on both ends facing the first electrode 4 and the second electrode of the extraction electrode 6 have, in plan view, a shape that is concavely curved from the width direction center side toward both end sides, respectively. Otherwise, the configuration is substantially the same as that of the above protective element 1A.

Furthermore, the protective element 1E of the present embodiment may be suitably used for the above protection circuit 100 in place of the above protective element 1A.

In the protective element 1E of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In particular, in the protective element 1E of the present embodiment, due to the ends on both sides of the extraction electrode 6 facing the first electrode 4 and the second electrode 5 described above having a concave curved shape from the center side to both end sides in the width direction, respectively, the surface area S3 of the region E of the extraction electrode 6 overlapping the fusible conductor 9 in plan view can be expanded while lowering the resistance of the extraction electrode 6.

In this way, the protective element 1E of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1E of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Sixth Embodiment

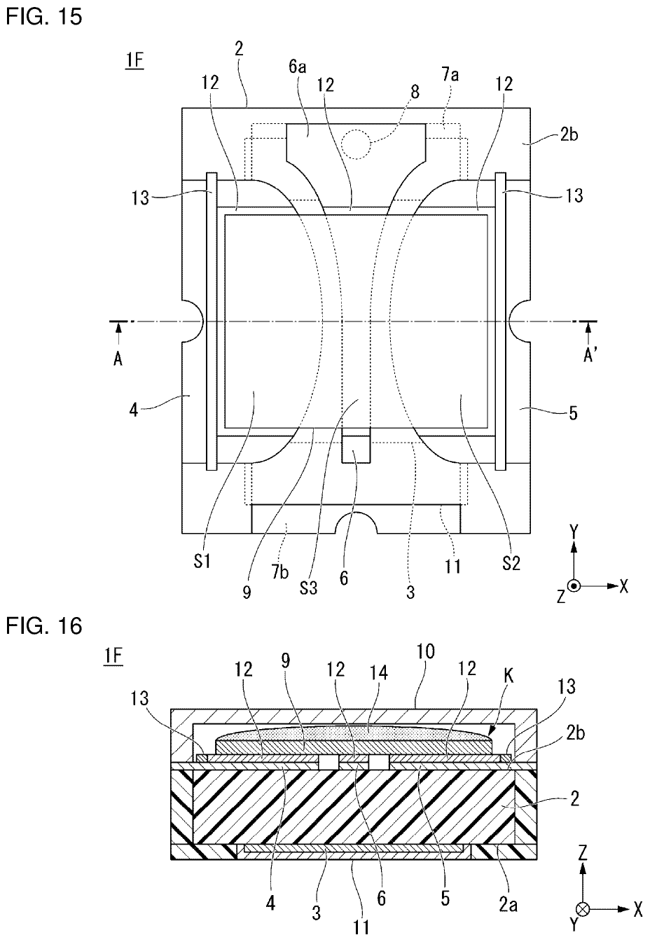

Next, as a sixth embodiment of the present invention, for example, a protective element 1F illustrated in FIG. 15 and FIG. 16 will be described.

Note that FIG. 15 is a plan view of a configuration of the protective element 1F. FIG. 16 is a cross-sectional view of the protective element 1F along the line segment A-A′ illustrated in FIG. 15. Furthermore, in the following description, parts equivalent to those of the protective element 1A described shall be omitted and the same symbols shall be used in the drawings.

As illustrated in FIG. 15 and FIG. 16, in the protective element 1F of the present embodiment, the ends on both sides of the extraction electrode 6 facing the first electrode 4 and the second electrode 5 have, in plan view, a shape that is concavely curved from the one end side toward the other end side in the width direction. Otherwise, the configuration is substantially the same as that of the above protective element 1A.

Furthermore, the protective element 1F of the present embodiment may be suitably used for the above protection circuit 100 in place of the above protective element 1A.

In the protective element 1F of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In particular, in the protective element 1F of the present embodiment, due to the ends on both sides of the extraction electrode 6 facing the first electrode 4 and the second electrode 5 described above having a concave curved shape from the one end side to the other end side in the width direction, the surface area S3 of the region E of the extraction electrode 6 overlapping the fusible conductor 9 in plan view can be expanded while lowering the resistance of the extraction electrode 6.

Furthermore, in the protective element 1F of the present embodiment, the interval between the first electrode 4 and the extraction electrode 6 and the interval between the second electrode 5 and the extraction electrode 6 described above are progressively larger from the width direction center side toward the other end side, and thus it is possible to further reduce the possibility that part of the fusible conductor 9 remains connected between the first electrode 4 and the extraction electrode 6 and between the second electrode 5 and the extraction electrode 6.

In this way, the protective element 1F of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1F of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Seventh Embodiment

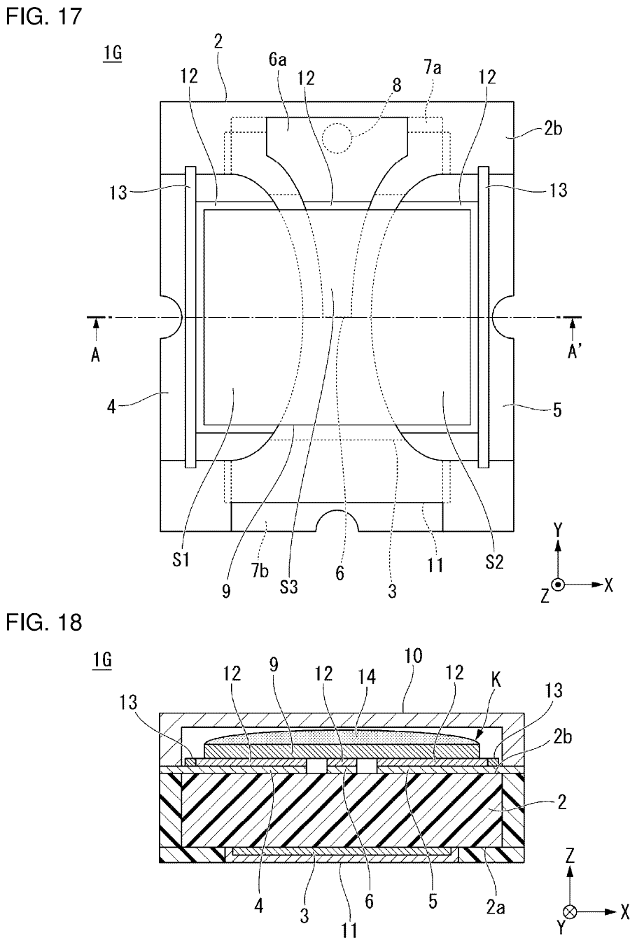

Next, as a seventh embodiment of the present invention, for example, a protective element 1G illustrated in FIG. 17 and FIG. 18 will be described.

Note that FIG. 17 is a plan view of a configuration of the protective element 1G. FIG. 18 is a cross-sectional view of the protective element 1G along the line segment A-A′ illustrated in FIG. 17. Furthermore, in the following description, parts equivalent to those of the protective element 1A described shall be omitted and the same symbols shall be used in the drawings.

As illustrated in FIG. 17 and FIG. 18, in the protective element 1G of the present embodiment, the ends on both sides of the extraction electrode 6 facing the first electrode 4 and the second electrode 5 have, in plan view, a shape that is concavely curved from the one end side toward the other end side in the width direction, and the length of the region E of the extraction electrode 6 overlapping the fusible conductor 9 in plan view is shortened between the first electrode 4 and the second electrode 5. Otherwise, the configuration is substantially the same as that of the above protective element 1A.

Furthermore, the protective element 1G of the present embodiment may be suitably used for the above protection circuit 100 in place of the above protective element 1A.

In the protective element 1G of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In particular, in the protective element 1G of the present embodiment, due to the ends on both sides of the extraction electrode 6 facing the first electrode 4 and the second electrode 5 described above having a concave curved shape from the one end side to the other end side in the width direction, the surface area S3 of the region E of the extraction electrode 6 overlapping the fusible conductor 9 in plan view can be expanded while lowering the resistance of the extraction electrode 6.

Furthermore, in the protective element 1G of the present embodiment, by shortening the length in the region E of the extraction electrode 6 that overlaps in plan view with the fusible conductor 9 described above, it is possible to further reduce the possibility of a portion of the fusible conductor 9 remaining connected between the first electrode 4 and the extraction electrode 6 and between the second electrode 5 and the extraction electrode 6.

In this way, the protective element 1G of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1G of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Eighth Embodiment

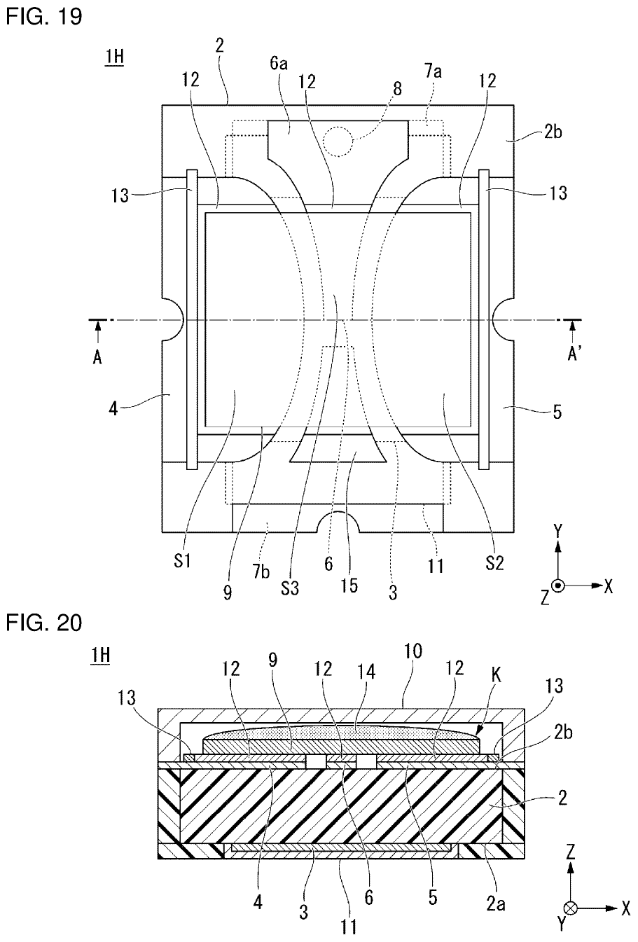

Next, as an eighth embodiment of the present invention, for example, a protective element 1H illustrated in FIG. 19 and FIG. 20 will be described.

Note that FIG. 19 is a plan view of a configuration of the protective element 1H. FIG. 20 is a cross-sectional view of the protective element 1H along the line segment A-A′ illustrated in FIG. 19. Furthermore, in the following description, parts equivalent to those of the protective element 1A described shall be omitted and the same symbols shall be used in the drawings.

As illustrated in FIG. 19 and FIG. 20, in the protective element 1H of the present embodiment, the ends on both sides of the extraction electrode 6 facing the first electrode 4 and the second electrode 5 have, in plan view, a shape that is concavely curved from the one end side toward the other end side in the width direction, and the length of the region E of the extraction electrode 6 overlapping the fusible conductor 9 in plan view is shortened between the first electrode 4 and the second electrode 5. Furthermore, a fourth electrode 15, which is separated from the extraction electrode 6, is provided on the other side of the region E. The ends on both sides of the fourth electrode facing the first electrode 4 and the second electrode 5 may have, in plan view, a shape that is concavely curved from the one end side toward the other end side in the width direction. Otherwise, the configuration is substantially the same as that of the above protective element 1A.

Furthermore, the protective element 1H of the present embodiment may be suitably used for the above protection circuit 100 in place of the above protective element 1A.

In the protective element 1H of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In particular, in the protective element 1H of the present embodiment, due to the ends on both sides of the extraction electrode 6 facing the first electrode 4 and the second electrode 5 described above having a concave curved shape from the one end side to the other end side in the width direction, the surface area S3 of the region E of the extraction electrode 6 overlapping the fusible conductor 9 in plan view can be expanded while lowering the resistance of the extraction electrode 6.

Furthermore, in the protective element 1H of the present embodiment, by shortening the length in the region E of the extraction electrode 6 that overlaps in plan view with the fusible conductor 9 described above, it is possible to further reduce the possibility of a portion of the fusible conductor 9 remaining connected between the first electrode 4 and the extraction electrode 6 and between the second electrode 5 and the extraction electrode 6.

Moreover, in the protective element 1H of the present embodiment, by providing a fourth electrode 15 separated from the extraction electrode 6 on the other side of the region E of the extraction electrode 6 overlapping in plan view with the fusible conductor 9 described above, even when the length of the extraction electrode 6 is shortened, it is possible to reduce the resistance of the electrically electrode 6 and the fourth electrode 15, which is electrically connected to the first electrode 4 and the second electrode 5 via the fusible conductor 9.

In this way, the protective element 1H of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

Therefore, the protective element 1H of the present embodiment can prevent a part of the fusible conductor 9 from remaining connected between the first electrode 4 and the extraction electrode 6 and between the second electrode 5 and the extraction electrode 6 when the first fuse element 107a and the second fuse element 107b are melted.

### Ninth Embodiment

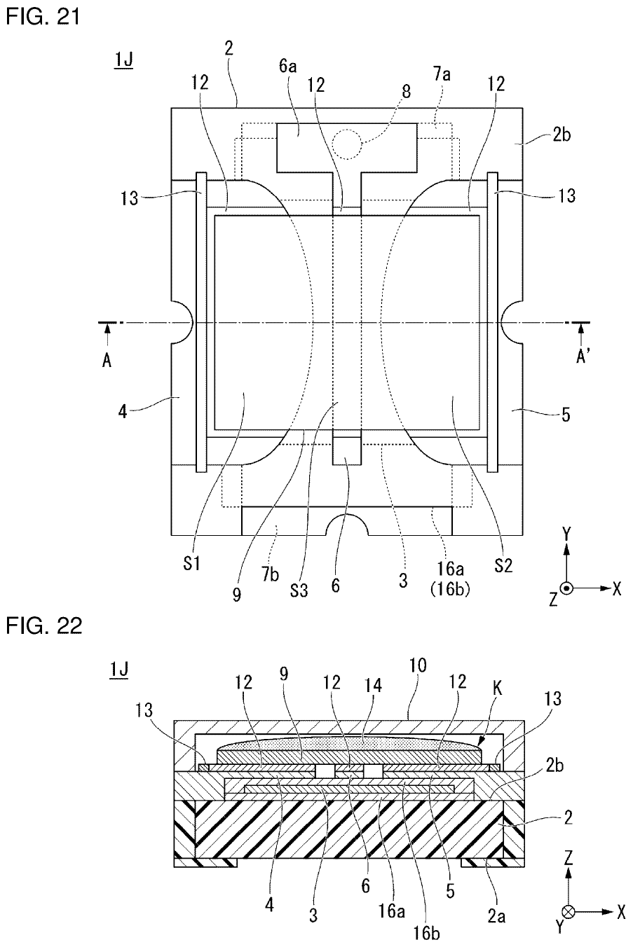

Next, as a ninth embodiment of the present invention, for example, a protective element 1J illustrated in FIG. 21 and FIG. 22 will be described.

Note that FIG. 21 is a plan view of a configuration of the protective element 1J. FIG. 22 is a cross-sectional view of the protective element 1J along the line segment A-A′ illustrated in FIG. 21. Furthermore, in the following description, parts equivalent to those of the protective element 1A described shall be omitted and the same symbols shall be used in the drawings.

In the protective element 1J of the present embodiment, the heat-generating body 3 is disposed on the other face 2b of the insulating substrate 2, as illustrated in FIGS. 21 and 22. Otherwise, the configuration is substantially the same as that of the above protective element 1A.

Specifically, the heat-generating body 3 is disposed on the other face 2b of the insulating substrate 2 via the first insulating layer 16a. Furthermore, a second insulating layer 16b is disposed on the other face 2b of the insulating substrate 2 to cover the heat-generating body 3. The first electrode 4, the second electrode 5, and the extraction electrode 6 are disposed on the other face 2b of the insulating substrate 2 on which this heat-generating body 3 is provided. The heat-generating body 3 may be connected to the other third electrode 7b via a surface electrode and a through electrode (through hole) formed on the other face 2b of insulating substrate 2 to form a heat-generating body energizing path with the outside.

Furthermore, the protective element 1J of the present embodiment may be suitably used for the above protection circuit 100 in place of the above protective element 1A.

In the protective element 1J of the present embodiment having such a configuration, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating body 3 to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In this way, the protective element 1J of the present embodiment can appropriately melt the fusible conductor 9 (first fuse element 107a and second fuse element 107b) between the first electrode 4, the second electrode 5, and the extraction electrode 6 by the heat generated by the heat-generating body 3 (heater 108).

### Tenth Embodiment

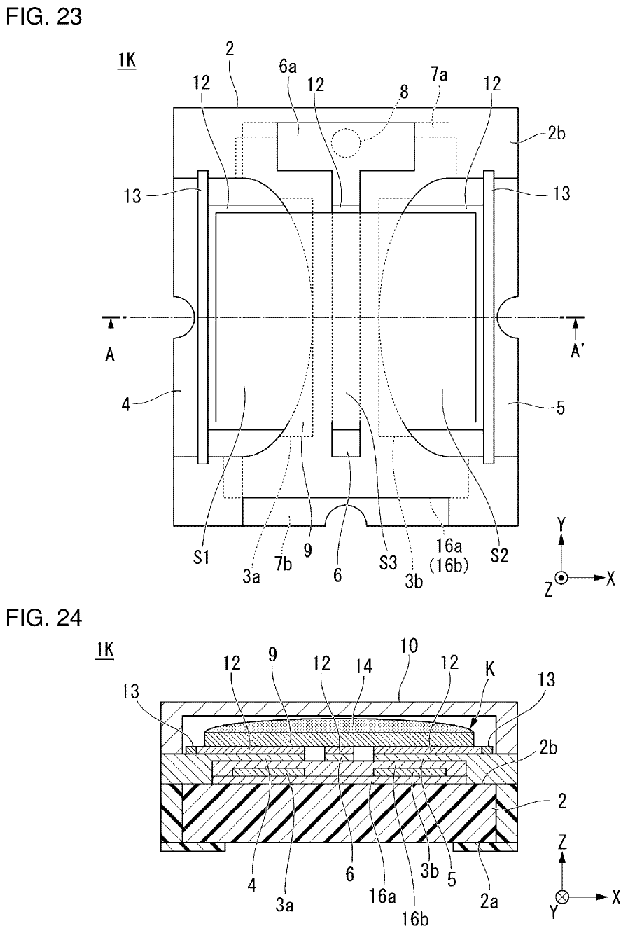

Next, as a tenth embodiment of the present invention, for example, a protective element 1K illustrated in FIG. 23 and FIG. 24 will be described.

Note that FIG. 23 is a plan view of a configuration of the protective element 1K. FIG. 24 is a cross-sectional view of the protective element 1K along the line segment A-A′ illustrated in FIG. 23. Furthermore, in the following description, parts equivalent to those of the protective element 1A described shall be omitted and the same symbols shall be used in the drawings.

In the protective element 1K of the present embodiment, a pair of heat-generating bodies 3a and 3b is disposed on the other face 2b of the insulating substrate 2, as illustrated in FIGS. 23 and 24. Otherwise, the configuration is substantially the same as that of the above protective element 1A.

Specifically, this pair of heat-generating bodies 3a and 3b is disposed on the other face 2b of the insulating substrate 2 via the first insulating layer 16a. Furthermore, a second insulating layer 16b is disposed on the other face 2b of the insulating substrate 2 to cover the heat-generating body 3. The first electrode 4, the second electrode 5, and the extraction electrode 6 are disposed on the other face 2b of the insulating substrate 2 on which this pair of heat-generating bodies 3a and 3b is provided.

As a result, of the pair of heat-generating bodies 3a and 3b, the one heat-generating body 3a is disposed to overlap at least a portion of the first electrode 4 in plan view, and the other heat-generating body 3b is disposed to overlap at least a portion of the second electrode 5 in plan view.

Furthermore, the protective element 1K of the present embodiment can be suitably used for the above protection circuit 100 in place of the above protective element 1A.

In the protective element 1K of the present embodiment having a configuration such as the above, the surface area S3 of the fusible conductor 9 disposed on the face of an extraction electrode 6 is smaller than the surface area S1 of the fusible conductor 9 located on the face of the first electrode 4 and the surface area S2 of the fusible conductor 9 located on the face of the second electrode 5 (S1>S3, S2>S3).

This allows the fusible conductor 9 fused by the heat generated by heat-generating bodies 3a and 3b to flow into the first electrode 4 and the second electrode 5 sides more than into the extraction electrode 6 side when a first fuse element 107a and a second fuse element 107b fuse, so that the fusible conductor 9 can fuse and separate between the first electrode 4 and the extraction electrode 6 as well as between the second electrode 5 and extraction electrode 6.

In this way, the protective element 1K of the present embodiment can appropriately melt the fusible conductor 9 (first fuse element 107a and second fuse element 107b) between the first electrode 4, the second electrode 5, and the extraction electrode 6 by the heat generated by the heat-generating bodies 3a and 3b (heater 108).

Note that the present invention is not necessarily limited to the above embodiments, and various changes can be made without departing from the essence of the present invention.

For example, although the above protective elements 1A to 1K are suitable for the protection circuit 100 that protects rechargeable batteries such as lithium-ion batteries from abnormalities such as overcharge and overcurrent as described above, they can also be widely applied to other protection circuits.

### Industrial Applicability

According to the present invention, it is possible to provide a protective element that makes it possible to appropriately melt a fusible conductor between a first electrode, a second electrode, and an extraction electrode by the heat generated by a heat-generating body.

### DESCRIPTION OF REFERENCE NUMERALS

1A to 1K . . . Protective element 2 . . . Insulating substrate 3 . . . Heat-generating body 3a . . . One heat-generating body 3b . . . Other heat-generating body 4 . . . First electrode 5 . . . Second electrode 6 . . . Extraction electrode 7a, 7b . . . Third electrode 8 . . . Through electrode 9 . . . Fusible conductor 10 . . . Cover member 11 . . . Insulating layer 12 . . . Connecting conductor 13 . . . Insulating layer 14 . . . Flux 15 . . . Fourth electrode 16a . . . First insulating layer 16b . . . Second insulating layer 100 . . . Protection circuit 101 . . . Battery 102a . . . External positive terminal 102b . . . External negative terminal 103 . . . Primary protection IC 104a, 104b . . . FET switch 105 . . . Secondary protection IC 106 . . . FET switch 107a . . . First fuse element 107b . . . Second fuse element 108 . . . Heater

1. A protective element comprising:
an insulating substrate;
a heat-generating body disposed on either one face side or the other face side of the insulating substrate;
a first electrode and a second electrode disposed on the other face side of the insulating substrate;
an extraction electrode disposed between the first electrode and the second electrode and electrically connected to one end side of the heat-generating body;
a third electrode electrically connected to the other end side of the heat-generating body; and
a fusible conductor disposed on a face of the first electrode, the second electrode, and the extraction electrode, and electrically connecting the first electrode to the extraction electrode and the second electrode to the extraction electrode, wherein
a surface area of the fusible conductor disposed on a face of the extraction electrode is smaller than each of a surface area of the fusible conductor disposed on a face of the first electrode and a surface area of the fusible conductor disposed on a face of the second electrode.

2. The protective element according to claim 1, wherein when the fusible conductor is fused between the first electrode and the extraction electrode and, between the second electrode and the extraction electrode, a maximum thickness of the fusible conductor remaining on the face of the extraction electrode is smaller than a maximum thickness of the fusible conductors remaining on the faces of the first electrode and the second electrode.

3. The protective element according to claim 1, wherein each of the first electrode and the second electrode has, in plan view, a shape in which an edge facing the extraction electrode is convexly curved from a center side to both end sides in a width direction of the protective element.

4. The protective element according to claim 1, wherein the fusible conductor is heated and fused either by heat generated by the current flowing in the heat-generating body or by Joule heat generated by an overcurrent flowing between the first electrode and the second electrode.

5. The protective element according to claim 1, wherein the heat-generating body is disposed on the one face side of the insulating substrate.

6. The protective element according to claim 1, further comprising a through electrode that penetrates through the insulating substrate and electrically connects the heat-generating body and the extraction electrode.

7. The protective element according to claim 1, wherein the heat-generating body is disposed so that at least a portion thereof overlaps each of the first electrode, the second electrode, and the extraction electrode in plan view.

8. The protective element according to claim 6, wherein the extraction electrode is disposed between the first electrode and the second electrode, led outward from one side of a region overlapping the fusible conductor in plan view to outside of the region.

9. The protective element according to claim 8, further comprising a fourth electrode on the other side of the region, being separated from the extraction electrode.

10. The protective element according to claim 1, wherein the extraction electrode has, in plan view, a shape in which each edge facing the first electrode and facing the second electrode is concavely curved from a center side to both end sides in a width direction of the protective element.

11. The protective element according to claim 1, wherein the extraction electrode has, in plan view, a shape in which each edge facing the first electrode and facing the second electrode is concavely curved from one end side to the other end side in a width direction of the protective element.

12. The protective element according to claim 1, wherein the heat-generating body is disposed on the other face side of the insulating substrate.

13. The protective element according to claim 1, further comprising an insulating layer covering the heat-generating body.

14. The protective element according to claim 1, wherein the heat-generating body comprises one heat-generating body disposed to overlap at least a portion of the first electrode in plan view and the other heat-generating body disposed to overlap at least a portion of the second electrode in plan view.

15. The protective element according to claim 1, wherein the fusible conductor is made of solder.

16. The protective element according to claim 15, wherein a flux is disposed on a surface of the fusible conductor.

17. The protective element according to claim 1, further comprising a cover member covering the other face side of the insulating substrate.
